(19) United States
(12) Patent Application Publication
(10) Pub. No.: US 2013/0082606 A1
(43) Pub. Date: Apr. 4, 2013

(54) DEVICE AND METHOD FOR AUTOMATIC CALIBRATION OF ILLUMINATION SYSTEM AND ENERGY SAVING

(71) Applicants: Yehiel Viner, Shoam (IL); Amir Poznansky, Tel Aviv (IL)

(72) Inventors: Yehiel Viner, Shoam (IL); Amir Poznansky, Tel Aviv (IL)

(21) Appl. No.: 13/252,445

(22) Filed: Oct. 4, 2011

(51) Int. Cl. H05B 37/02

(52) U.S. Cl. 315/152

(57) ABSTRACT

The present invention provides a system for testing monitoring and calibrating illumination of plurality of lamps, operated by a control node. The system is comprised of: plurality of lamps units each unit including, a lamp, and control node for controlling power consumption wherein the control node comprises at least one of: a wireless, PLC transceiver or twisted pair, at least one mobile measurement device, for performing luminous measurements for each lamp unit and a computing unit for analyzing the luminous measurements results for determining the optimal parameters for operating the lamp according to the predefined luminous requirements for each lamp unit

The present invention relates generally to methods and systems for automatic calibration of illumination system and more specifically to methods and apparatus for automatic control and calibration of electronic ballast and LED driver, and energy saving.

### BACKGROUND OF THE INVENTION

Over the past few decades there has been a significant increase in the number of new systems for urban illumination system control. The most important feature in every lighting system is to ensure it delivers the exact lighting intensity needed.

Because of the electrical distribution system, in most urban systems the light performance cannot be adjusted. However the common way to do it, is to control the voltage supply to the lamp from the feeder pillar or by calibrating the lamp's ballast or the LED driver.

US patent application US2010/0277072A1 disclose a pulse width modulated supply voltage signal (PWM) which controls an electronic switch, in a high frequency operation, in order to reduce the voltage supply to the lamp's driver, especially to LED lamps. In this invention, a main controller said LAMPid control the electronic ballast or th ld driver and regulates the exact parameter for optimal operation.

### SUMMARY OF THE INVENTION

The present invention provides a system for testing monitoring and calibrating illumination of plurality of lamps, operated by a control node. The system is comprised of: plurality of lamps units, each unit including, a lamp, and control node for controlling power consumption wherein the control node comprises at least one of: a wireless, PLC transceiver or twisted pair, at least one mobile measurement device, for performing luminous measurements for each lamp unit; and a computing unit for analyzing the luminous measurements results for determining the optimal parameters for operating the lamp according to the predefined luminous requirements for each lamp unit.

The lamp unit is operated according to determined optimal parameters.

According to some embodiments of the present invention the system further comprises a power ignition unit wherein the ignition and power unit is at least one of: an LED driver, HID ballast, plasma lamp, induction lamp or florescent lamp.

According to some embodiments of the present invention system furthers comprises: at least one local controller associated with group of lamps units, wherein the computing unit transmits the determined optimal parameters to the control node through the local controller, wherein the local controller communicates with the control node via communication link, wherein the communication link is at least one of: PLC wireless communication, or twisted pair communication line.

According to some embodiments of the present invention the system further comprises: at least one local controller associated with group of lamps units, a control network for managing and transmitting the determined optimal parameters to the lamp units, wherein each lamp unit has a unique ID and a central sever for managing the control network and the local controller, wherein the computing unit is located at the central server and includes a lighting management software to analyze the measurements data results according to pre-defined template or algorithm of thresholds for determining the optimal parameters data for operating the lamp according to the predefined luminous requirements for each lamp unit; wherein the determined optimal parameters are transmitted to the control node though a local controller.

According to some embodiments of the present invention the system further comprises: a control network for controlling the operation of the power supply to the lamp units, wherein each control unit has a unique ID, a central sever for managing the control network and the plurality of lamps, wherein the computing unit is located at the central server and includes a lighting management software for analyzing the testing results according to pre-defined template of thresholds for determining the calibration data of dimming levels for each street lamp and wherein the determined optimal parameters are transmitted to the control unit though a communication data network or twisted pair.

According to some embodiments of the present invention the system of the algorithm implements operation scheduling for setting the power for each lamp unit.

According to some embodiments of the present invention the control network is one of RF communication, PLC communication or TP communication.

According to some embodiments of the present invention the calibration process is preformed periodically based on lamp aging implications for providing updated lighting power to each lamp, eliminating the usage of maintenance factor, hence increasing the life time of the each lamp.

According to some embodiments of the present invention the server includes data history of measured luminance for detecting abnormal behavior of lamps unit.

According to some embodiments of the present invention the mobile measurement device is vehicle which integrates measurements instruments enabling an automatic testing operation mode, wherein the luminous testing includes measurements of the following parameters areal luminance, glare and reflection.

According to some embodiments of the present invention the optimal parameters is calculated according to the optimum parameters of the group of measured lamps unit.

According to some embodiments of the present invention at least part of analyzing the measurements results are preformed at the mobile measurement device.

According to some embodiments of the present invention the mobile measurements device is a human operated measuring unit.

The present invention provides a method for testing, monitoring and measuring illumination of plurality of lamps units. The method comprised the steps of: performing luminous measurements for each lamp unit, transmitting measurements from mobile testing device to local controller or central server or lamp control unit, analyzing measurement based on given template or algorithm of pre-defined thresholds value, determining optimal parameters for operating the lamp according to the predefined luminous requirements for each lamp based on measurements analysis, transmitting determined power values for each lamp to local controller or the lamp control unit or central server and operating the lamp according to optimal parameters to achieve the required luminous parameters.

According to some embodiments of the present invention the measurements results are transmitted though control communication network to the central server.

According to some embodiments of the present invention the calibration process is preformed periodically based on lamp aging implications for providing updated lighting power to each lamp, eliminating the use of maintenance factor, hence increasing the life time of the each lamp. According to some embodiments of the present invention the server includes data history of measured luminance for detecting abnormal behavior of lamps, hence reducing damage in lamps.

According to some embodiments of the present invention the measurements are preformed by vehicle which integrates measurements instruments enabling an automatic measurements operation mode, wherein the luminous measurements includes measurements of the following parameters areal luminance glare and reflection.

According to some embodiments of the present invention the optimal parameters are calculated according to the optimum parameters of the group of measured lamps.

According to some embodiments of the present invention at least part of analyzing the measurements results are preformed at the mobile measurement device.

According to some embodiments of the present invention the testing is preformed by a human operated measuring unit.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified pictorial illustration showing a street lighting pole and indoor lamp, comprising one electronic ballast; or LED driver RF unit, LED driver, PLC; TP; RF communication unit, according to some embodiments of the present invention.

FIG. 2 is a simplified pictorial illustration showing a group of street or indoor floating lamps connected to the main controller at the feeder pillar, called LAMPid concentrator.

FIG. 3 is a graphical scheme illustrating the relationship between the output lumens of the lamps to the lifetime of LED lamps and HID lamps, up to the optimal axis.

FIG. 4 is a graphical scheme illustrates the relationship between the dimming profiles of a group of lamps, and the energy saving, according to the operation rules of the present invention.

FIG. 5 is a graphical scheme illustrates the communication design between the single lamps to the OCC of the present invention.

FIG. 6 is a simplified pictorial illustration showing the of the measurement process, according to some embodiments of the present invention.

FIG. 7 is a graphical flowchart illustrates the logical process of the system components, according to some embodiments of the present invention.

FIG. 8 is a graphical flowchart illustrates the logical process of the measurement and calibration, according to some embodiments of the present invention.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

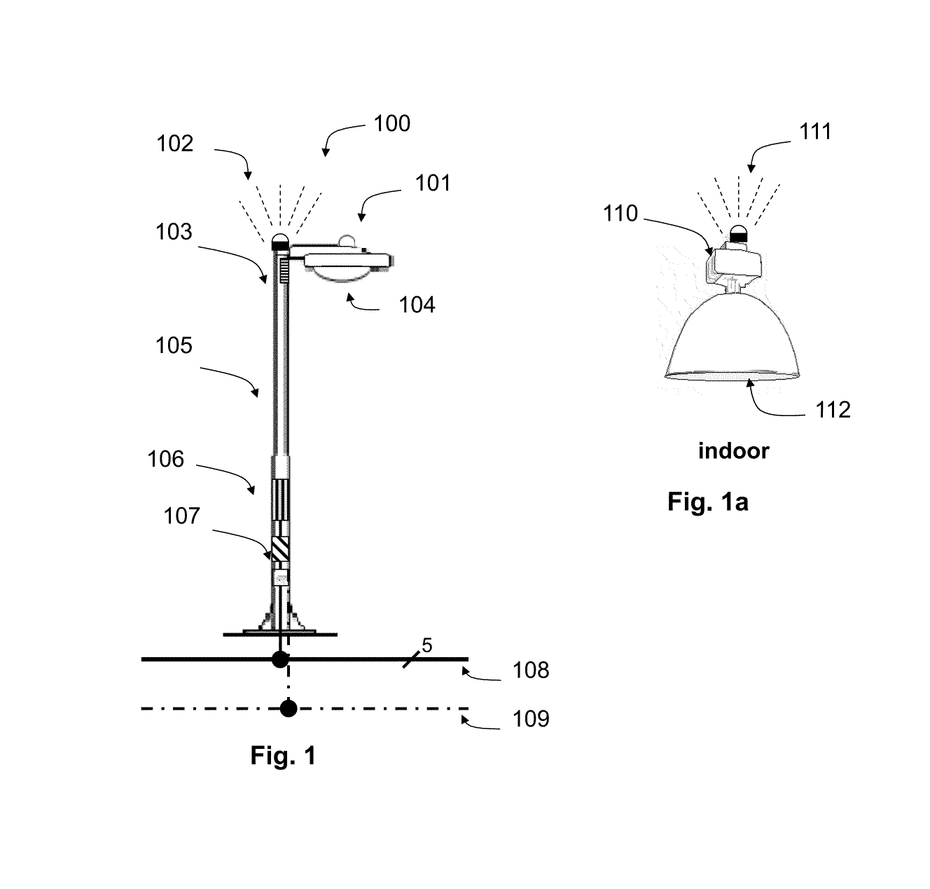

Reference is now made to FIG. 1, which is a simplified pictorial illustration showing a street pole comprising a photo cell unit 101, an RF communication unit 102, electronic ballast 106 for HPS lamps 104 and a LED driver 103.

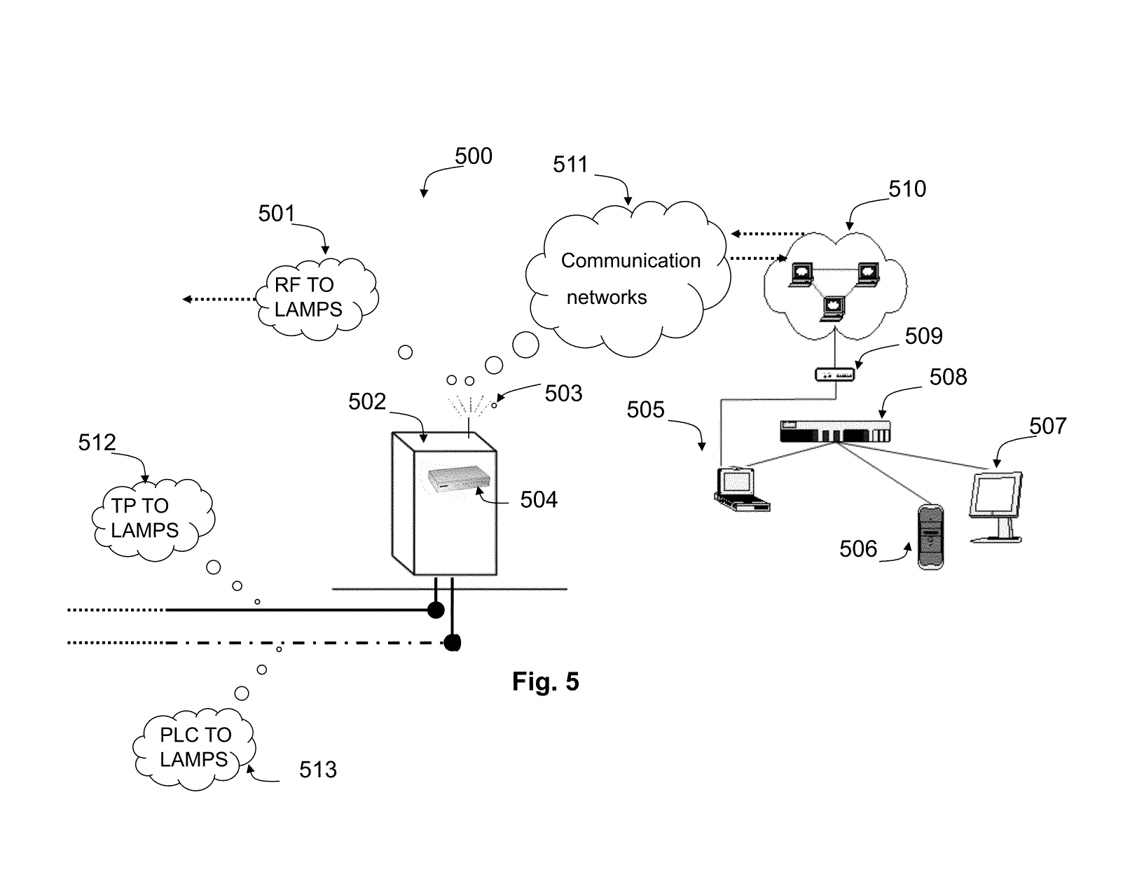

The pole is fed from 3 phase cables 108, and communicates with the concentrator 504 (as shown in FIG. 5) which is installed at the feeder pillar 502 through a phase PLC unit (power line communication) 107 or by twisted pair communication lines 109. The PLC unit is mounted in the lighting pole 105. In the case of indoor array lamp the RF unit 111 is installed at the lamps 112 casing. The ignition devices of LED driver, or HID ballast are installed together with the communication unit in the lamps casing.

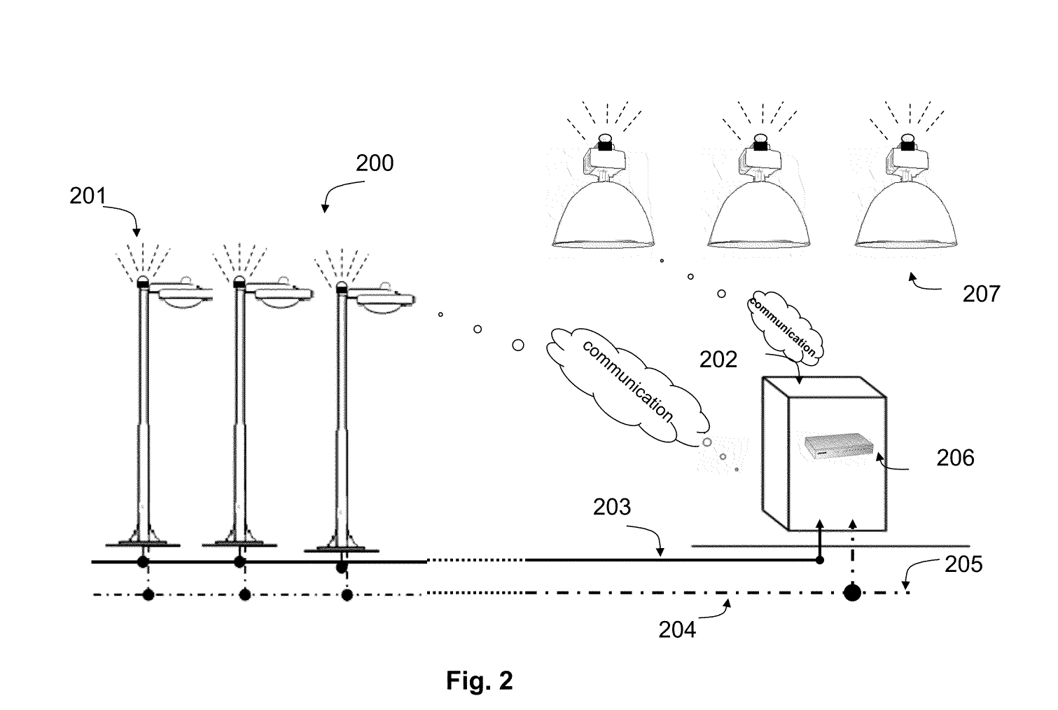

Reference is now made to FIG. 2, which is a simplified detailed pictorial drawing illustrating a part of a street light system 200. A group of street lighting poles 200 or indoor floating lamps 207 are connected to the main controller 206 at the feeder pillar 202 (called LAMPid concentrator), which communicates with the lamps by Power Line Communication PLC 204, TP (twisted pair) 203 or RF communication 201. The controller is optionally connected by the serial connection 205 which connects between the current feeder pillar 202 and the next feeder pillar through data communication line such as TCPIP. The same implementation can be used for indoor instillation 207.

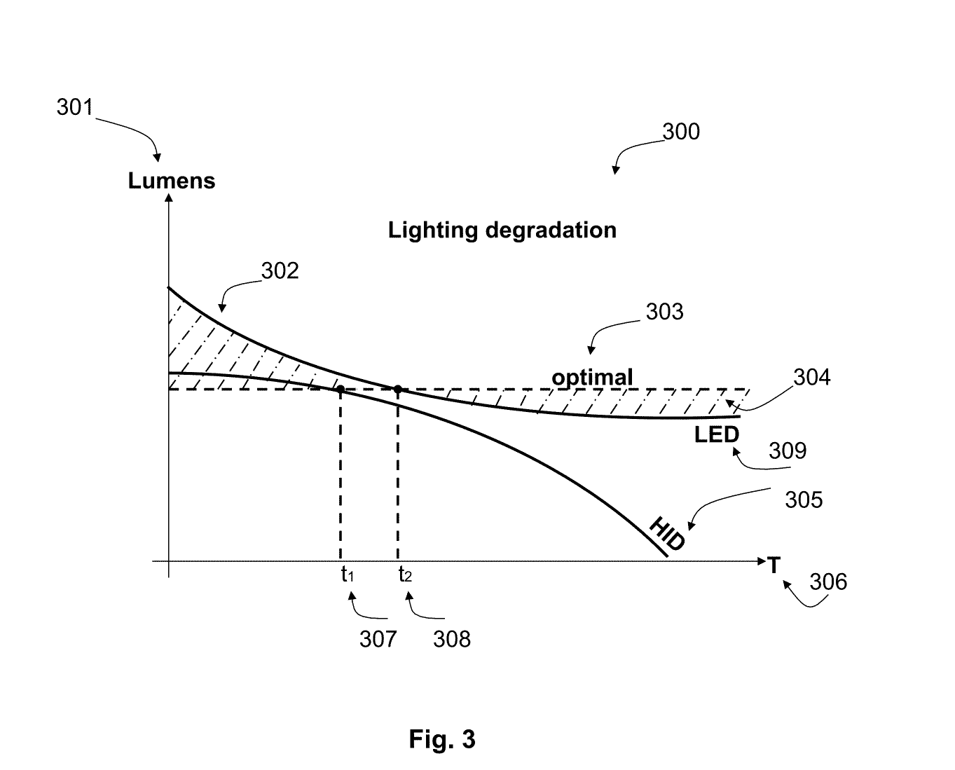

Reference is now made to FIG. 3, which is a graphical scheme illustrating the relationship between the output lumens 301 of the lamps to the time line of LED 309 lamps and HID lamps 305 lifetime 306, in reference to the optimal axis 306. The designer selects new lamps 302 which their initial lighting power is above the optimal requirement considering the lighting degradation of the lamps during its lifetime 306. The system can restrict the ignition and power devices to operate at the optimal conditions till point t1 307(where the power light of the HID is at the optimal state). When working at optimal conditions the system save energy equivalent to the dotted area 302 period. The system according to the present invention changes the lamps power to the optimum power during the degradation time, up the point 304 of the lamp life time. This operation of the system can change each of the lamps group to the optimum according to the group characters(such groups of lamps in a junction), during the lamp life circle 306, maintaining the optimal parameters while saving energy during the operation.

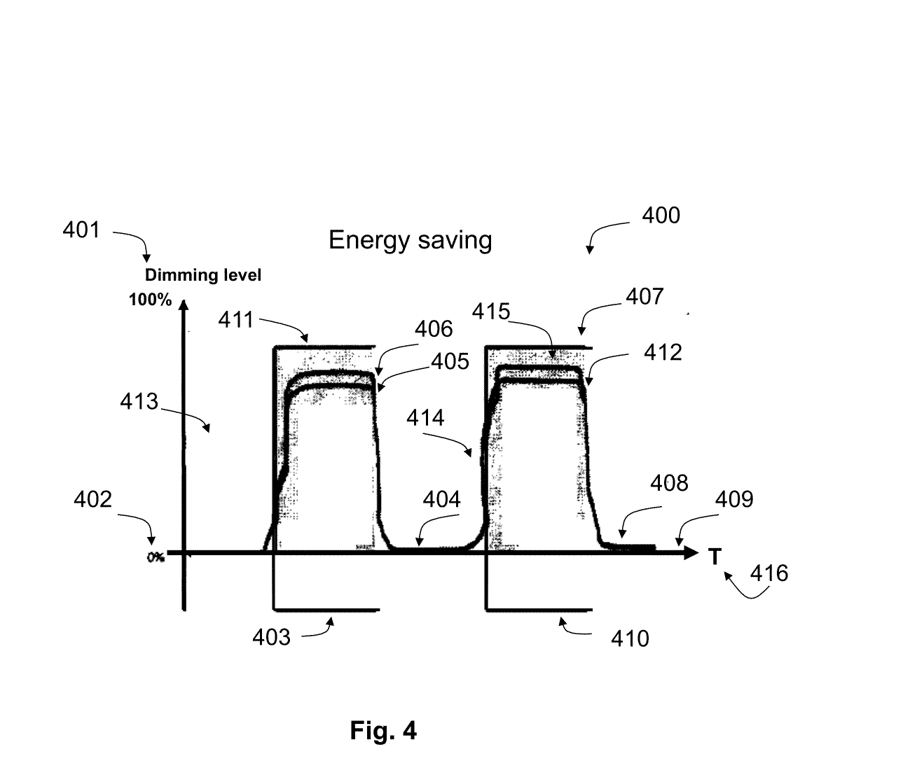

Reference is now made to FIG. 4 which is a simplified detailed pictorial graph 400. The graph illustrates the dimming levels percentage 401 of an array of street poles said group, along the time axis 409. The square columns 403, 410, 411, 407 represent the dimming levels in a night time zone, while the white columns 413, 414 represent the day time zone. The curved line along points 405, 404, 412, 408 represent the required level of light, said the optimal parameters for operation. The upper lines of points 406, 415 show the current lighting level of the group. The system target is to calculate the lighting of the group of poles, rather than the individual poles, in order to optimize the lighting parameters, and the aggregate dimming level's values of all the poles in the group. The difference between the upper lines 406, 415 to the low one 405, 412 represent an energy loss. When the difference between the lines is negative, the amount of light supplied by the system is lower than the required one. In order to provide the optimal lighting levels it is required to calculate the correlation (by transformation formula) between the optimal lighting level and actual light supplied by the illuminating devices.

There are two categories of parameters which affect this relationship between the required dimming level and the actual one: Global properties and Local properties which are both depended on the environment conditions.

Based on the required calibration of a given ballasts 106 or drivers 103 HPS lamps 104 or LED and taking into account the actual age 204, 203 of the lamps 104 for each individual lamp 104, the optimal lighting policy of the whole group and the dimming cycle are estimated.

Selecting the optimal dimming policy depends on the periodical calibration and the information of each lamps 104 heterogeneity aging. As the devices are constantly being replaced the policy should be checked at predefined time periods.

The relation between the required dimming level and the actual one may be affected by the following parameters:

1. Type of the ballast.

2. Age of the ballast.

3. Type of the LED's driver.

4. The age of the LED's driver.

5. Environmental condition including: temperature, sun rise, and sun set time, location depended condition including concealment by objects such as buildings.

Reference is now made to FIG. 5, which illustrates the communication configuration between the different components of the system according to some embodiments of the present invention. The GPRS control device 511 enables communication between the concentrator 504 at the local feeder pillar 502 to the street poles 501 by RF communication or by PLC 513, or by TP 512. The concentrator 504 and the Operation Control Center OCC 510 communicate through wireless communication 511. The OCC 510 and server 109 may be controlled by at least one of: operation officer 505, cellular human operated application 506, or control terminal 507 via router 509.

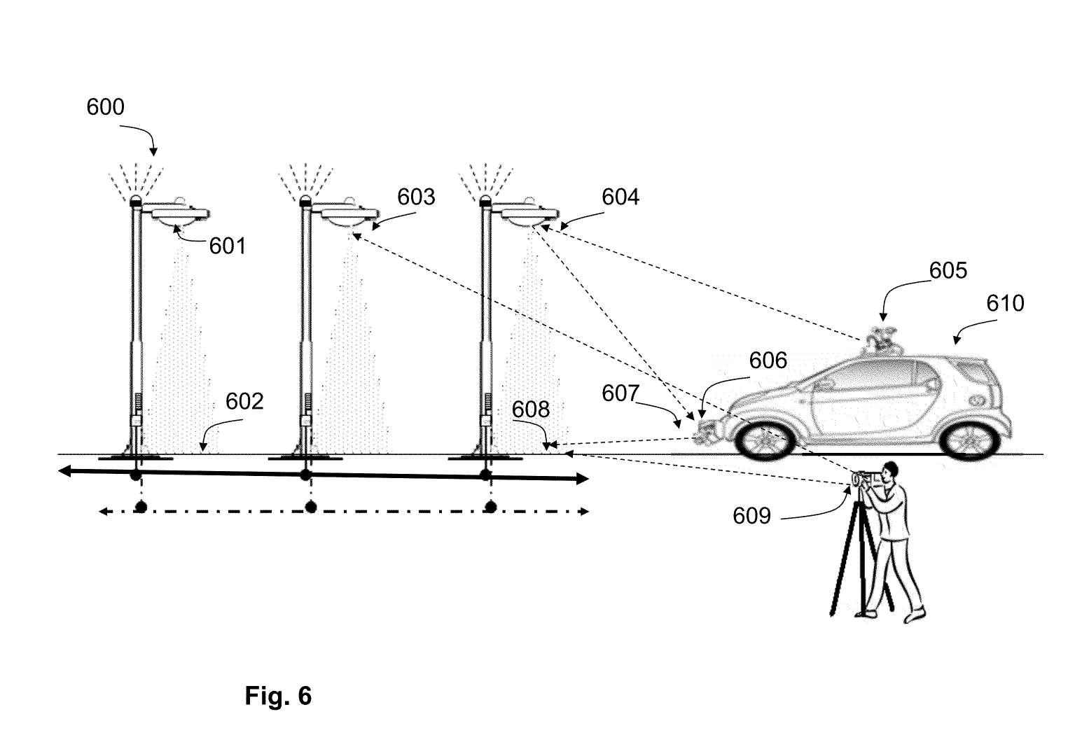

Reference is now made to FIG. 6 which a simplified detailed pictorial illustrating the measurement process according to some embodiments of the present invention. Two options are suggested according to the present invention: the first one is a manual human operated procedure 609, using a human operator which measures locally at least one of the following parameters: the lighting power of the lamps 601, the glare 603 or the lighting power at the road 602, (by LUX or CANDELS units).The manual measurements are compared to the optimal parameters, which have been calculated by the CPU. The CPU calculates the optimal lighting power parameters which fit to the road section in which the group of poles were measured. The new parameters are transmitted to the concentrator 504 through RF, MESH, GPRS communications 503, or directly to the RF unit 102 at the pole, in order to calibrate the new optimal parameters. From the concentrator 504 the optimal parameters are transmitted to the poles 105 by at least one of the following communication paths: PLC communication 108 to the PLC slave unit 107, by wires 109, or by RF communication 102. The manual operation 609 can transmit the data directly to the OCC 510 by mobile 506 or any other communication network, Or optionally feed the data in the feeder pillar at the concentrator.

The second option is an automatic measurement by a designated vehicle 610. The vehicle includes a built in measurement instruments, and LUX meter devices: on the horizontal 606 axis, and on the vertical one 607, 608, 602. The measurements units measure the following parameters: GLARE and LUMENS 601, 603, 604. In this option the results are analyzed by a computer installed in the car, which transmits the optimum data directly to the concentrator 504 at the feeder pillar 502 by GPRS 511 communication.

According to this automatic option, the system can provide quick, precise and efficient measurements of the group 200 of poles 105. As the process is automatic it requires less expenses, and can be preformed frequently to maintain a more efficient operation mode of the system during the lamps 104 aging 204.

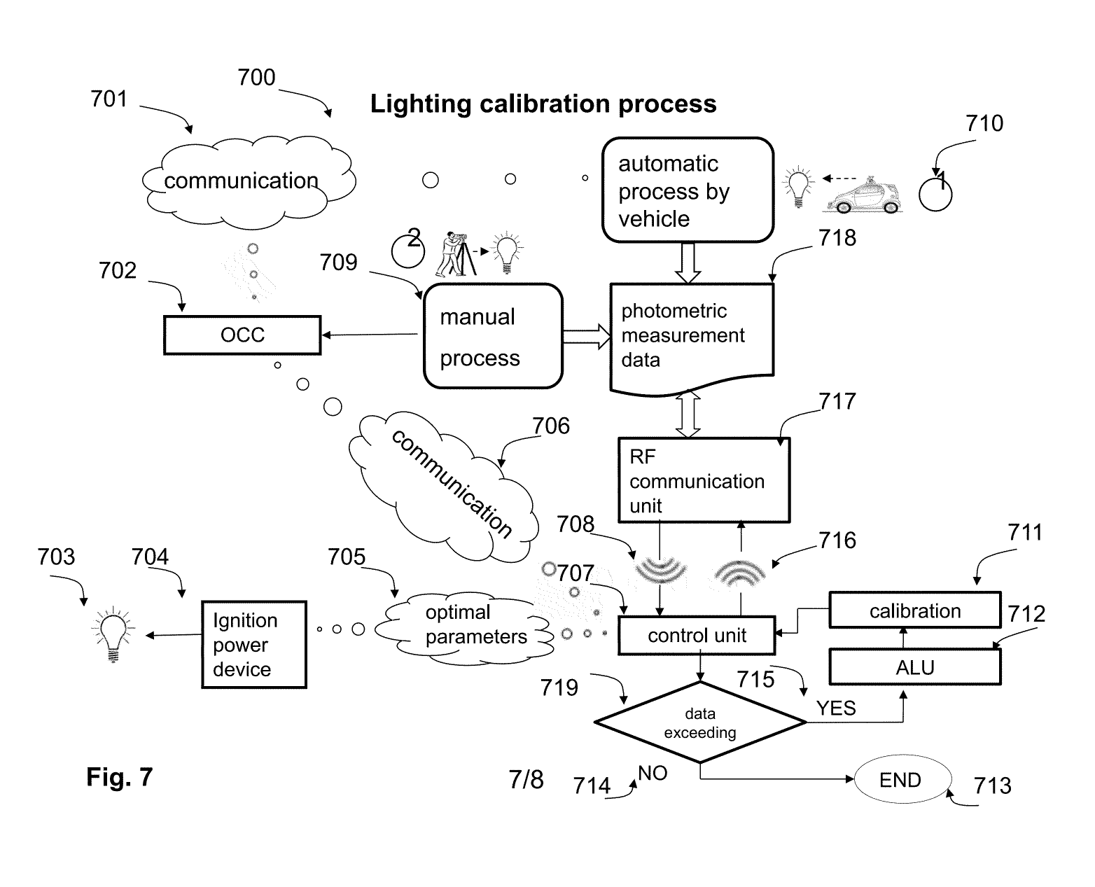

Reference is now made to FIG. 7, which is a simplified detailed flowchart illustrating the calibration process 700. The calibration process as suggested by the present invention can be implemented according to the manual option or the automatic option as described above. The calibration implementation utilizes existing lighting parameters measurements through the communications configuration as illustrated in FIG. 7.

The automatic calibration process which utilizes a vehicle 710 to collect the photometric measurement data 718, and transmits 716 the data by RF communication unit 717 to the LAMPid 206 concentrator at the feeder pillar 302. At the next step the data is sent 708 by wireless network 701 and/or communication network 706 to the OCC 702. The data can be optionally analyzed in a vehicle computer for checking 719, if the light measurements exceeded the optimum. In case the measurement exceeded 715 the optimum the arithmetic logical unit ALU 712 in the car computer calculates and calibrates 711 the new parameters based on the optimal parameters 705 and transmits 716 the new parameters by RF communication from the controller 707, back to the concentrator 206. From the concentrator 206 the new parameters are transmitted by RF or PLC or TP communication 512 to the ignition and power devices 704 and forwarded to the lamps 703. In case the measurements don't exceeds the optimum, not new calculation are executed, and the process is terminated 713.

According to the manual option 709, preformed by a human operator. The measured data is transmitted directly to the OCC 702, recorded at electric storage device.

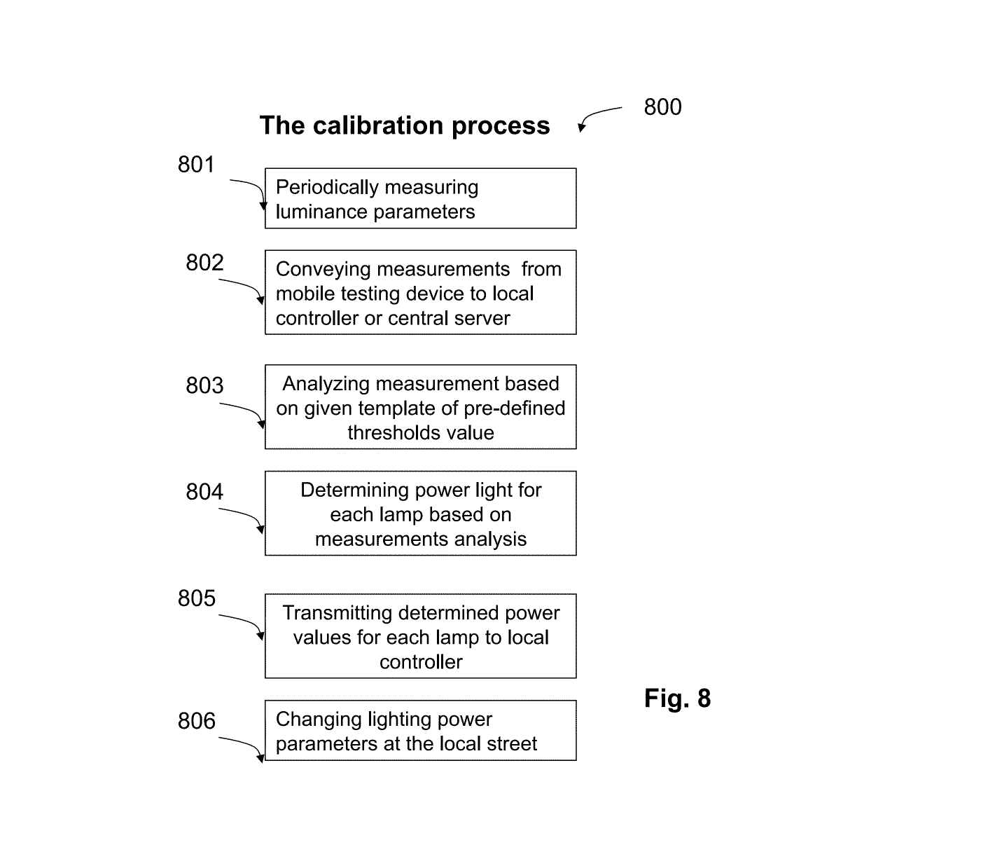

Reference is now made to FIGS. 8 which is a graphical flowchart illustrating the logical process of the lighting measurement 800 and calibration. The lighting parameters are measured periodically 801, the measured data is conveyed 802 from the calibration devices to the OCC 702. At the OCC 702 or at the lighting computer in the vehicle 610 the measured data are analyzed 803. In the automatic mode 710 option, calibration data is calculated 711 (step 804) according to the optimum parameters of the whole group 200. The calculated calibration data is transmitted back 708 (step 805) to the concentrator 206. At the end of the process, the lighting power of the street light 101 is set to the optimum value 806, using the electronic ballast 704 (106 in FIG. 1) or the LED driver 103.

According to some embodiments of the present invention the measured lighting parameters are at least one of the following:
E=luminance at specific area
r—Reflection
g—Glare

Based on these measurements are calculated the following parameters:
U=Emin/Emax: representing the distribution of luminance across the street.
Luminous efficacy
M=maintenance factor=+30% of the lamps power, in order to prevent from the aging implications.

Only the power of the lamp can be controlled by the electronic balance or the LED driver using digital or analog input of the devices.

Based on the power calibration 711 the system can affect all the above lighting parameters, not requiring any mechanic transformation, such as changing the position of the reflector or the tiles angel of the lighting arms and the lamp 104 base.

Accordingly, the power level change 711 is determined according to a predefined template of the optimum levels or predefined algorithm, calculating the specific lighting parameters of the group 200. This template profile may be affected by at least one of the following sources: input/output (I/O) events, astronomic clock, individual photocell 101, photometer, some of the sources are deterministic, such as the astronomic clock, others are non deterministic and may vary along the time base on I/O events.

According to some embodiments of the present invention, a sampling program is created per individual lamp 104 and per group 320. The sample 802 includes the actual measurements 718 of the light power. The measurements are collected by a field measuring devices 609, 606, 607, 605 which are capable to measure actual light samples measurements of poles 603, 604, and 608. The measurements are entered to the system periodically 801.

Once the required amount of samples is collected and stored 718 in the system 712, the system has the minimum required information of the sampled lamps aging, for automatically calibration 711. The more samples 801 are collected and stored in the system, the more accurate and updated version of these curves can be calculated 712. Having the actual properties of each group 200, the system can examine the measurements and alert 716 in cases when the heterogeneity within a group 200 affect the efficiency of template activation. It also is further suggested to calculate the decomposition of inefficient groups 200.

The system enables to provide the precise power at the ballast 106 or at the drivers 103 in the exact life time period 409 of the lamps life cycle 104 and to eliminate the need to use maintenance factor, when planning the construction of the street lighting configuration in a new project. The use of maintenance factor results increase of around 30% in the calculated required lighting power; for taking into account the lamp aging implications 202, therefore the invention increase the life time of the individual lamp and the group as the whole.

For each group 200 of street lamps, the system will calculate 712 the optimal values and then respective operation template 806 based on the group lamp properties.

According to some embodiments of the present invention, the system provides an automatic economic alert, based on the system calculations 712 of the economic value of deviation 406, from the optimal template 405. In a case of deviation 715, is above a predetermined value which was determined by the user an alert 716 is transmitted. The alert can be generated in the OCC 510, or by the system CPU at the vehicle 610.

Another type of alert can be generated when the system identifies a rapid aging process of devices. Such rapid change may occur due to local environmental conditions or specific encountered defected in the lamps which requires rapid replacement of units within the lamp.

The references cited herein teach many principles that are applicable to the present invention. Therefore the full contents of these publications are incorporated by reference herein where appropriate for teachings of additional or alternative details, features and/or technical background.

It should be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A system for testing monitoring and calibrating illumination of plurality of lamps, operated by a control node, said system comprised of:
plurality of lamps units, each unit including, a lamp, and control node for controlling power consumption wherein the control node comprises at least one of: a wireless, PLC transceiver or twisted pair;
at least one mobile measurement device, for performing luminous measurements for each lamp unit; and
a computing unit for analyzing the luminous measurements results for determining the optimal parameters for operating the lamp according to the predefined luminous requirements for each lamp unit
wherein the lamp unit is operated according to determined optimal parameters.

2. The system of claim 1 further comprising a power ignition unit wherein the ignition and power unit is at least one of: an LED driver, HID ballast, plasma lamp, induction lamp or florescent lamp.

3. The system of claim 1 further comprising:
at least one local controller associated with group of lamps units;
wherein the computing unit transmits the determined optimal parameters to the control node through the local controller, wherein the local controller communicates with the control node via communication link, wherein the communication link is at least one of: PLC wireless communication, or twisted pair communication line.

4. The system of claim 1 further comprising:
at least one local controller associated with group of lamps units;
a control network for managing and transmitting the determined optimal parameters to the lamp units, wherein each lamp unit has a unique ID;
a central sever for managing the control network and the local controller;
wherein the computing unit is located at the central server and includes a lighting management software to analyze the measurements data results according to pre-defined template or algorithm of thresholds for determining the optimal parameters data for operating the lamp according to the predefined luminous requirements for each lamp unit;
wherein the determined optimal parameters are transmitted to the control node though a local controller.

5. The system of claim 1 further comprising:
a control network for controlling the operation of the power supply to the lamp units, wherein each control unit has a unique ID;
a central sever for managing the control network and the plurality of lamps;
wherein the computing unit is located at the central server and includes a lighting management software for analyzing the testing results according to pre-defined template of thresholds for determining the calibration data of dimming levels for each street lamp;
wherein the determined optimal parameters are transmitted to the control unit though a communication data network or twisted pair.

6. The system of claim 3 wherein the algorithm implements operation scheduling for setting the power for each lamp unit.

7. The system of claim 1 wherein the control network is one of RF communication, PLC communication or TP communication.

8. The system of claim 1 wherein the calibration process is preformed periodically based on lamp aging implications for providing updated lighting power to each lamp, eliminating the usage of maintenance factor, hence increasing the life time of the each lamp.

9. The system of claim 1 wherein the server includes data history of measured luminance for detecting abnormal behavior of lamps unit.

10. The system of claim 1 wherein the mobile measurement device is vehicle which integrates measurements instruments enabling an automatic testing operation mode, wherein the luminous testing includes measurements of the following parameters areal luminance, glare and reflection.

11. The system of claim 5 wherein the optimal parameters is calculated according to the optimum parameters of the group of measured lamps unit.

12. The system of claim 1 wherein at least part of analyzing the measurements results are preformed at the mobile measurement device.

13. The system of claim 1 wherein the mobile measurements device is a human operated measuring unit.

14. A method for testing, monitoring and measuring illumination of plurality of lamps units, said method comprised the steps of:
performing luminous measurements for each lamp unit;
transmitting measurements from mobile testing device to local controller or central server or lamp control unit.
analyzing measurement based on given template or algorithm of pre-defined thresholds value;
determining optimal parameters for operating the lamp according to the predefined luminous requirements for each lamp based on measurements analysis;
transmitting determined power values for each lamp to local controller or the lamp control unit or central server; and
operating the lamp according to optimal parameters to achieve the required luminous parameters.

15. The method of claim 14 wherein the measurements results are transmitted though control communication network to the central server

16. The method of claim 14 wherein the calibration process is preformed periodically based on lamp aging implications for providing updated lighting power to each lamp, eliminating the use of maintenance factor, hence increasing the life time of the each lamp.

17. The method of claim 14 wherein the server includes data history of measured luminance for detecting abnormal behavior of lamps, hence reducing damage in lamps.

18. The method of claim 14 wherein the measurements are preformed by vehicle which integrates measurements instruments enabling an automatic measurements operation mode, wherein the luminous measurements includes measurements of the following parameters areal luminance, glare and reflection.

19. The method of claim 14 wherein the optimal parameters are calculated according to the optimum parameters of the group of measured lamps.

20. The method of claim 14 wherein at least part of analyzing the measurements results are preformed at the mobile measurement device.

21. The method of claim 14 wherein testing is preformed by a human operated measuring unit.

22. The system of claim 4 wherein the algorithm implements operation scheduling for setting the power for each lamp unit.

23. The system of claim 5 wherein the algorithm implements operation scheduling for setting the power for each lamp unit.
